(19) United States
(12) Patent Application Publication
(10) Pub. No.: US 2020/0139532 A1
(43) Pub. Date: May 7, 2020

(54) Combination Screwdriver Tool

(71) Applicant: Hsuen-Hsuan Wang, Yuanli Jen (TW)

(72) Inventor: Hsuen-Hsuan Wang, Yuanli Jen (TW)

(21) Appl. No.: 16/180,068

(22) Filed: Nov. 5, 2018

(51) Int. Cl. B25G 1/08; B25B 23/16; B25G 1/10

(52) U.S. Cl. CPC B25G 1/085; B25G 3/04; B25G 1/102; B25B 23/16

(57) ABSTRACT

A combination screwdriver tool includes a tool connector, a main unit connected with the tool connector, and a rear cover connected with the main unit. The main unit includes multiple connecting sections located between the tool connector and the rear cover. The connecting sections and the rear cover receive a plurality of screwdriver tips. Thus, the combination screwdriver tool stores and provides multiple screwdriver tips of different shapes, sizes, and specifications. In addition, the number of the connecting sections is adjusted freely.

### BACKGROUND OF THE INVENTION

### 1. Field of the Invention

The present invention relates to a hand tool and, more particularly, to a combination screwdriver tool.

### 2. Description of the Related Art

A conventional screwdriver tool comprises a handle, a shank and a driving head. The driving head is connected with a tip for driving a workpiece, such as a screw or the like. The tip has different shapes, such as flat shape, cross shape, star shape or the like, so as to fit screws of different types. Thus, the conventional screwdriver tool has to cooperate with tips of different kinds, sizes, shapes, and specifications. However, the conventional screwdriver tool cannot receive many tips, so that the user has to provide a tool box to carry and store the multiple tips additionally, thereby causing inconvenience to the user.

### BRIEF SUMMARY OF THE INVENTION

The primary objective of the present invention is to provide a combination screwdriver tool having a handle that is divided into multiple parts which are connected together to receive multiple tips.

In accordance with the present invention, there is provided a combination screwdriver tool comprising a tool connector, a main unit connected with the tool connector, and a rear cover connected with the main unit. The tool connector has a first end provided with a mounting head, and a second end provided with a first mounting recess. The first mounting recess has an inner periphery provided with a first flange, and a plurality of first positioning slots. The main unit includes at least one connecting section which has an interior provided with a plurality of first receiving holes for receiving a plurality of screwdriver tips. The at least one connecting section has a first end provided with a first fitting portion, and a second end provided with a second mounting recess. The first fitting portion is provided with a plurality of first fitting pieces mounted in the first positioning slots of the tool connector. Each of the first fitting pieces has an outer periphery provided with a first groove positioned on the first flange of the tool connector. The second mounting recess has an inner periphery provided with a second flange, and a plurality of second positioning slots. The rear cover has an interior provided with a plurality of second receiving holes for receiving the screwdriver tips. The rear cover has an end provided with a second fitting portion. The second fitting portion is provided with a plurality of second fitting pieces mounted in the second positioning slots of the at least one connecting section. Each of the second fitting pieces has an outer periphery provided with a second groove positioned on the second flange of the at least one connecting section.

According to the primary advantage of the present invention, the screwdriver tips are stored in the first receiving holes of the connecting sections, and the second receiving holes of the rear cover, such that the combination screwdriver tool provides multiple screwdriver tips of different shapes, sizes, and specifications, so as to satisfy the user's different requirements.

According to another advantage of the present invention, the number of the connecting sections is adjusted freely according to the user's practical requirement.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a combination screwdriver tool in accordance with the preferred embodiment of the present invention.

FIG. 2 is an exploded perspective view of the combination screwdriver tool as shown in FIG. 1.

FIG. 3 is a perspective view of a tool connector of the combination screwdriver tool in accordance with the preferred embodiment of the present invention.

FIG. 4 is a side view of the tool connector as shown in FIG. 3.

FIG. 5 is a perspective view of a connecting section of the combination screwdriver tool in accordance with the preferred embodiment of the present invention.

FIG. 6 is another perspective view of the connecting section of the combination screwdriver tool in accordance with the preferred embodiment of the present invention.

FIG. 7 is a side view of the connecting section as shown in FIG. 5.

FIG. 8 is a side view of the connecting section as shown in FIG. 6.

FIG. 9 is a perspective view of a rear cover of the combination screwdriver tool in accordance with the preferred embodiment of the present invention.

FIG. 10 is a side view of the rear cover as shown in FIG. 9.

FIG. 11 is a partially exploded perspective view showing assembly of the tool connector and the connecting section of the present invention.

FIG. 12 is a partially exploded perspective view showing assembly of two connecting sections of the present invention.

FIG. 13 is a partially exploded perspective view showing assembly of the rear cover and the connecting section of the present invention.

FIG. 14 is a perspective view of a combination screwdriver tool in accordance with another preferred embodiment of the present invention.

FIG. 15 is a perspective view of a combination screwdriver tool in accordance with a further preferred embodiment of the present invention.

### DETAILED DESCRIPTION OF THE INVENTION

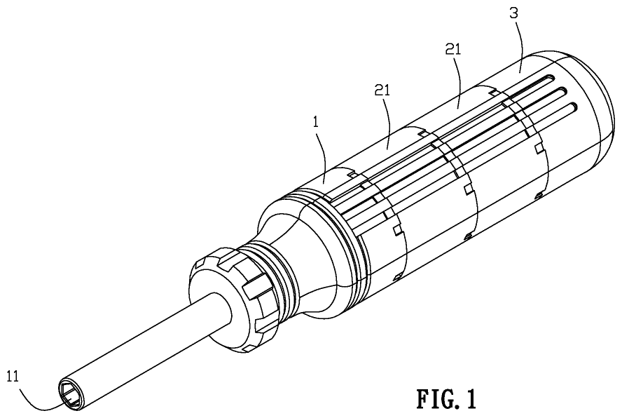

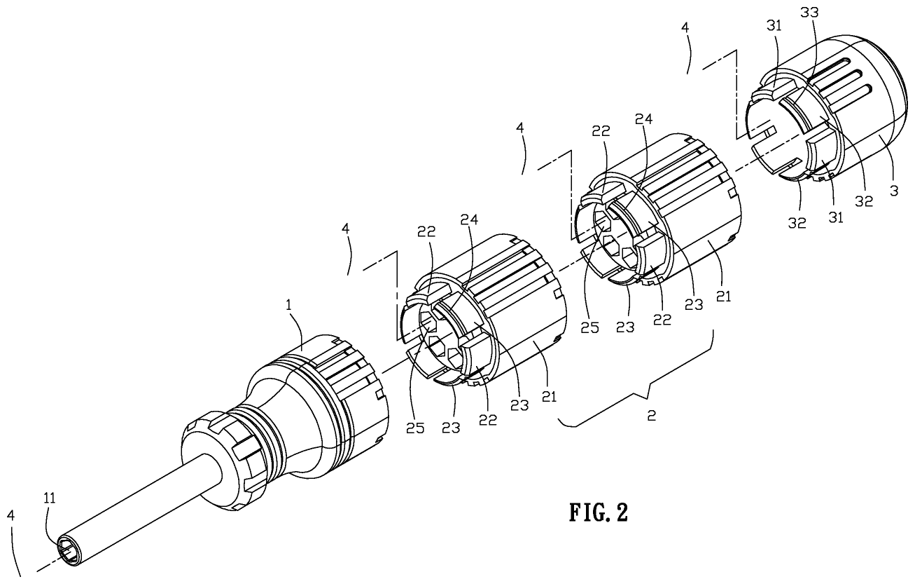

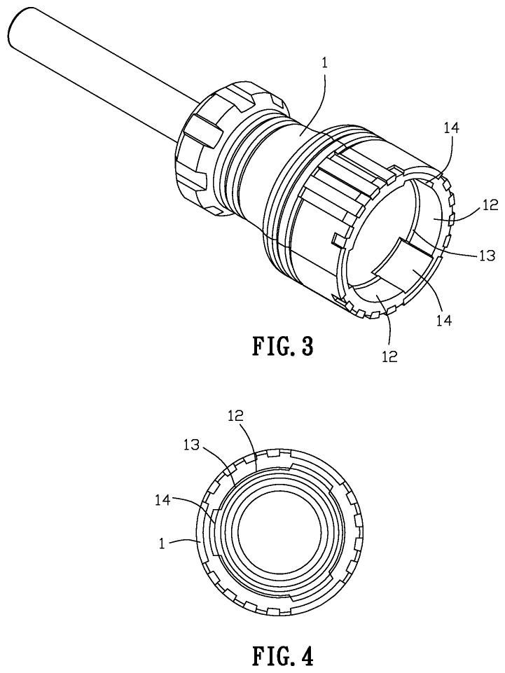

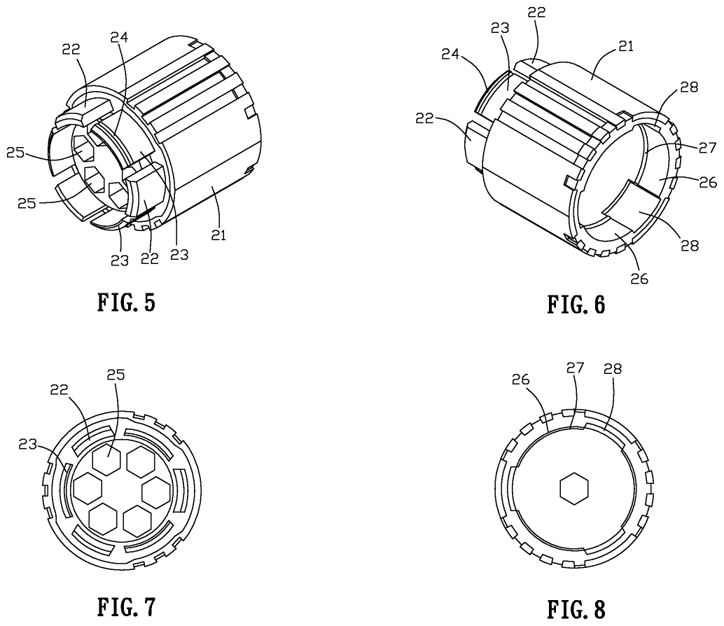

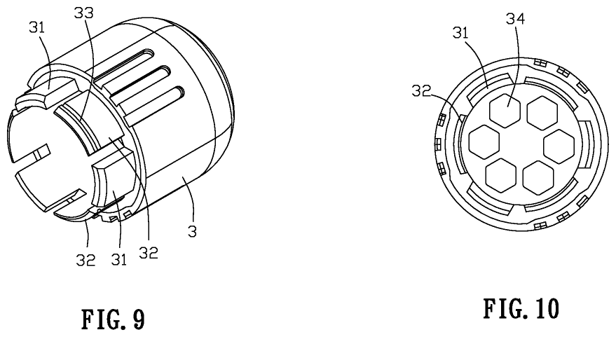

Referring to the drawings and initially to FIGS. 1-10, a combination screwdriver tool in accordance with the preferred embodiment of the present invention comprises a tool connector 1, a main unit 2 connected with the tool connector 1, and a rear cover 3 connected with the main unit 2.

The tool connector 1 has a first end provided with a mounting head 11, and a second end provided with a first mounting recess 12. The first mounting recess 12 has an inner periphery provided with a first flange 13, and a plurality of first positioning slots 14. The first positioning slots 14 are equally distant from each other.

The main unit 2 includes at least one connecting section 21 which has an interior provided with a plurality of first receiving holes 25 for receiving a plurality of screwdriver tips 4. One of the screwdriver tips 4 is inserted into the mounting head 11 of the tool connector 1. The at least one connecting section 21 has a first end provided with a first fitting portion 22, and a second end provided with a second mounting recess 26. The first fitting portion 22 is mounted in the first mounting recess 12 and is provided with a plurality of first fitting pieces 23 mounted in the first positioning slots 14 of the tool connector 1. The first fitting pieces 23 are equally distant from each other. Each of the first fitting pieces 23 has an outer periphery provided with a first groove 24 positioned on the first flange 13 of the tool connector 1. The second mounting recess 26 has an inner periphery provided with a second flange 27, and a plurality of second positioning slots 28. The second positioning slots 28 are equally distant from each other.

The rear cover 3 has an interior provided with a plurality of second receiving holes 34 for receiving the screwdriver tips 4. The rear cover 3 has an end provided with a second fitting portion 31. The second fitting portion 31 is mounted in the second mounting recess 26 of the at least one connecting section 21 and is provided with a plurality of second fitting pieces 32 mounted in the second positioning slots 28 of the at least one connecting section 21. The second fitting pieces 32 are equally distant from each other. Each of the second fitting pieces 32 has an outer periphery provided with a second groove 33 positioned on the second flange 27 of the at least one connecting section 21. In the preferred embodiment of the present invention, the main unit 2 includes a single connecting section 21.

In the preferred embodiment of the present invention, the main unit 2 includes a plurality of connecting sections 21 which are connected and combined with each other. As shown in FIG. 1, the main unit 2 includes two connecting sections 21.

In the preferred embodiment of the present invention, when the connecting sections 21 are connected, the first fitting portion 22 of one of the connecting sections 21 is mounted in the second mounting recess 26 of another one of the connecting sections 21, the first fitting pieces 23 of one of the connecting sections 21 are mounted in the second positioning slots 28 of another one of the connecting sections 21, and the first groove 24 of each of the first fitting pieces 23 of one of the connecting sections 21 is positioned on the second flange 27 of another one of the connecting sections 21.

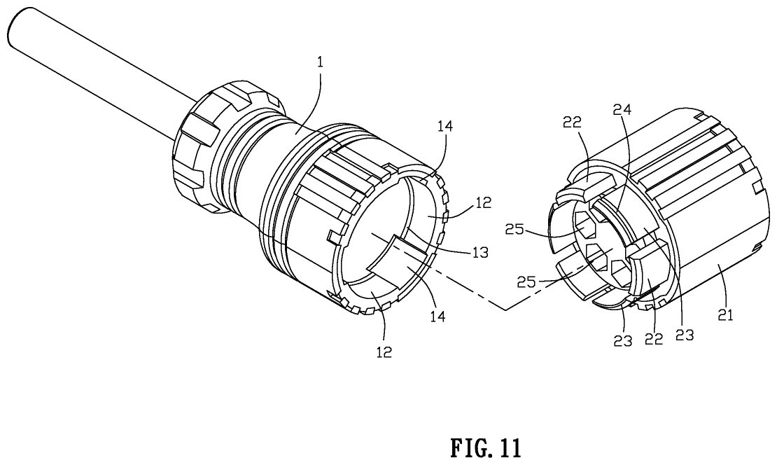

Referring to FIG. 11 with reference to FIGS. 1-10, the first fitting portion 22 is mounted in the first mounting recess 12, the first fitting pieces 23 are mounted in the first positioning slots 14 of the tool connector 1, and the first groove 24 of each of the first fitting pieces 23 is positioned on the first flange 13 of the tool connector 1. Thus, the at least one connecting section 21 is connected with the tool connector 1, without producing idle rotation between the at least one connecting section 21 and the tool connector 1.

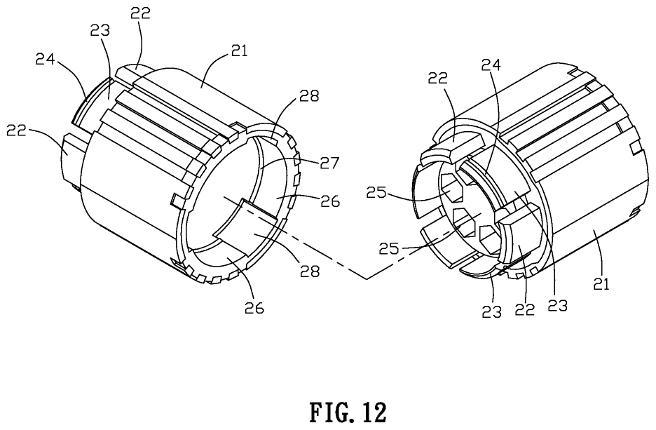

Referring to FIG. 12 with reference to FIGS. 1-10, when the connecting sections 21 are connected, the first fitting portion 22 of one of the connecting sections 21 is mounted in the second mounting recess 26 of another one of the connecting sections 21, the first fitting pieces 23 of one of the connecting sections 21 are mounted in the second positioning slots 28 of another one of the connecting sections 21, and the first groove 24 of each of the first fitting pieces 23 of one of the connecting sections 21 is positioned on the second flange 27 of another one of the connecting sections 21. Thus, any two of the connecting sections 21 are connected, without producing idle rotation therebetween.

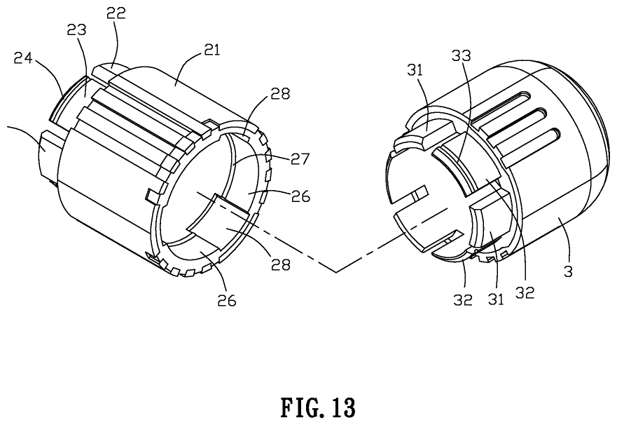

Referring to FIG. 13 with reference to FIGS. 1-10, the second fitting portion 31 is mounted in the second mounting recess 26 of the at least one connecting section 21, the second fitting pieces 32 are mounted in the second positioning slots 28 of the at least one connecting section 21, and the second groove 33 of each of the second fitting pieces 32 is positioned on the second flange 27 of the at least one connecting section 21. Thus, the rear cover 3 is connected with the at least one connecting section 21, without producing idle rotation between the rear cover 3 and the at least one connecting section 21.

After assembly, two of the connecting sections 21 are located between the tool connector 1 and the rear cover 3. In such a manner, the screwdriver tips 4 are received in and stored by the first receiving holes 25 of the connecting sections 21, and the second receiving holes 34 of the rear cover 3. Thus, the combination screwdriver tool provides the screwdriver tips 4 of different shapes, sizes, and specifications, so as to satisfy the requirement of different users.

In operation, the user only needs to apply a little force to release and detach the first groove 24 of each of the first fitting pieces 23 from the first flange 13 of the tool connector 1, so as to detach the at least one connecting section 21 from the tool connector 1, such that the screwdriver tips 4 can be removed from the at least one connecting section 21. Alternatively, the user only needs to apply a little force to release and detach the second groove 33 of each of the second fitting pieces 32 from the second flange 27 of the at least one connecting section 21, so as to detach the rear cover 3 from the at least one connecting section 21, such that the screwdriver tips 4 can be removed from the rear cover 3.

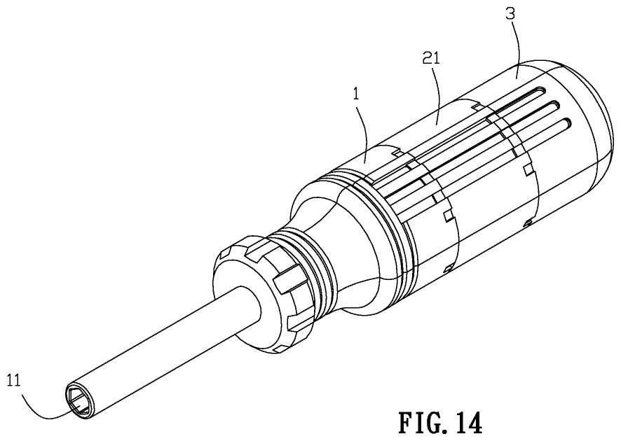

Referring to FIG. 14, only a single connecting section 21 is located between the tool connector 1 and the rear cover 3.

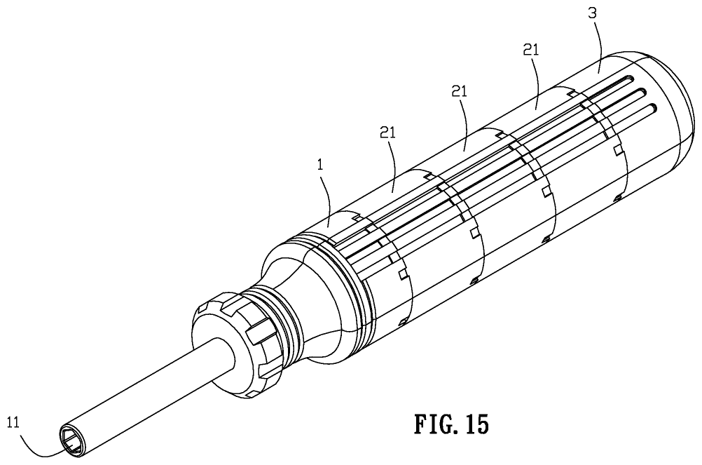

Referring to FIG. 15, three (or more than three) connecting sections 21 are located between the tool connector 1 and the rear cover 3.

Accordingly, the screwdriver tips 4 are stored in the first receiving holes 25 of the connecting sections 21, and the second receiving holes 34 of the rear cover 3, such that the combination screwdriver tool provides multiple screwdriver tips of different shapes, sizes, and specifications, so as to satisfy the user's different requirements, thereby facilitating the user operating the screwdriver tips 4. In addition, the number of the connecting sections 21 is adjusted freely according to the user's practical requirement, thereby facilitating the user carrying and storing the screwdriver tips 4.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A combination screwdriver tool comprising:
a tool connector;
a main unit connected with the tool connector; and
a rear cover connected with the main unit;
wherein:
the tool connector has a first end provided with a mounting head, and a second end provided with a first mounting recess;
the first mounting recess has an inner periphery provided with a first flange, and a plurality of first positioning slots;
the main unit includes at least one connecting section which has an interior provided with a plurality of first receiving holes for receiving a plurality of screwdriver tips;
the at least one connecting section has a first end provided with a first fitting portion, and a second end provided with a second mounting recess;
the first fitting portion is provided with a plurality of first fitting pieces mounted in the first positioning slots of the tool connector;
each of the first fitting pieces has an outer periphery provided with a first groove positioned on the first flange of the tool connector;
the second mounting recess has an inner periphery provided with a second flange, and a plurality of second positioning slots;
the rear cover has an interior provided with a plurality of second receiving holes for receiving the screwdriver tips;
the rear cover has an end provided with a second fitting portion;
the second fitting portion is provided with a plurality of second fitting pieces mounted in the second positioning slots of the at least one connecting section; and
each of the second fitting pieces has an outer periphery provided with a second groove positioned on the second flange of the at least one connecting section.

2. The combination screwdriver tool of claim 1, wherein the main unit includes a single connecting section.

3. The combination screwdriver tool of claim 1, wherein the main unit includes a plurality of connecting sections which are connected and combined with each other.

4. The combination screwdriver tool of claim 3, wherein the first fitting pieces of one of the connecting sections are mounted in the second positioning slots of another one of the connecting sections, and the first groove of each of the first fitting pieces of one of the connecting sections is positioned on the second flange of another one of the connecting sections.

5. The combination screwdriver tool of claim 4, wherein the first fitting portion of one of the connecting sections is mounted in the second mounting recess of another one of the connecting sections.

6. The combination screwdriver tool of claim 1, wherein the first fitting portion is mounted in the first mounting recess.

7. The combination screwdriver tool of claim 1, wherein the second fitting portion is mounted in the second mounting recess of the at least one connecting section.
